(19) United States
(12) Patent Application Publication
(10) Pub. No.: US 2004/0252855 A1
(43) Pub. Date: Dec. 16, 2004

(54) Hearing aid

(76) Inventors: Remir Vasserman, St. Paul, MN (US); Hans-Herbert Tuerk JR., Odenthal (DE); Jan Philipp Schmidt, Duesseldorf (DE)

Correspondence Address: BRIGGS AND MORGAN, P.A., 2200 IDS CENTER, MINNEAPOLIS, MN, 55402, US

(21) Appl. No.: 10/462,918

(22) Filed: Jun. 16, 2003

(51) Int. Cl. H04R 25/00; H04M 1/00

(52) U.S. Cl. 381/331; 381/312; 379/443

(57) ABSTRACT

A hearing aid includes a first microphone, a second microphone and a telephone coil for alternatively providing an electrical signal representative of a received acoustic signal, a magnetic switch and a plurality of programs for configuring the output from the microphones and the telephone coil. The hearing aid can further include a magnetic switch and a manual switch for selecting between inputs and programs. Upon detecting the presence of a magnetic field, the magnetic switch can automatically switch from the microphones to the telephone coil and change the program configuring the input. When the magnetic field is no longer present, the magnetic switch can automatically switch back to the microphone from the telephone coil and change the program configuring the input back to the program used before the exposure of the magnetic switch to the magnetic field. The manual switch can switch between the plurality of programs and between the microphones and telephone coil.

### BACKGROUND OF THE INVENTION

1. Field of the Invention

The present invention relates to hearing aids and, more particularly, to hearing aids having a telephone coil and a microphone.

2. Description of the Related Art

A hearing aid is a hearing device that generally amplifies sound to compensate for poor hearing and is typically worn by a hearing impaired individual. Hearing aids were traditionally adjustable only for volume. However, contemporary circuit designs and microprocessors have allowed for the adjustment and modifies of response to particular frequencies to better match the frequency dependent hearing characteristics of hearing impaired individuals.

Hearing aids can provide user adjustable operational modes or parameters that improve the performance of the hearing aid for a specific person or in a specific environment. A variety of parameters may be adjusted independently or in combination. Some of the parameters which may be adjusted include volume, tone, and signal input, among others. Historically, the control of these parameters has utilized a manual switch on the outside of the hearing aid. In some devices, this switch was used to switch between various circuits or programs that controlled the signal sent to the hearing aids processor. In other devices, this switch was used to switch between a microphone and a telephone coil. However, the operation of a switch while the hearing aid is positioned on or in a user's ear can be cumbersome and can draw unwanted attention to the presence of the hearing aid. Further, certain individuals may lack the dexterity to carry out this type of switching operation.

Some hearing aids now include magnetically activated switches. These switches can allow the adjustment of operational modes or parameters using a magnet. Typically, the switches are designed to respond to a magnet that is held adjacent to or is placed within the user's ear. Alternatively, the switches may be designed to respond to the magnetic field of the magnet within the earpiece of a phone. Generally, a magnetic actuator is held adjacent to the hearing aid and the magnetic switch changes the volume. However, such a hearing aid requires that a person have the magnetic switch available to change the mode of operation. Consequently, a person must carry some type of magnet to control the hearing aid.

In some magnetic switch controllable hearing aids, the circuitry for changing the volume must cycle through various preset volume levels to arrive at the desired setting. This form of adjustment can be slow, frustrating and tedious. Further, adequate time may not be available to cycle through the settings to arrive at the desired setting, such as for example, when a user must adjust the hearing aid before answering a telephone.

To reduce the need to adjust the hearing aid before answering a telephone, some hearing aids have an input that receives the electromagnetic voice signal directly from the telephone's voice coil instead of receiving the acoustic signal emanating from the telephone speaker. This is typically accomplished with a telephone coil. In the hearing aid industry, telephone coils are frequently alternatively referred to as telecoils or T-coils. Generally, a telephone coil is a device that receives the electromagnetic voice signal directly from the telephone's voice coil which is typically located in the telephone's earpiece. Typically, the telephone coil is in the form of an induction coil. In operation, the telephone coil converts magnetic energy to electrical energy, in much the same way that a microphone converts sounds waves to electrical energy. Although telephone coils were originally designed to work specifically with telephones, telephone coils can be used in any setting that provides an induction loop assistive listening system and other systems which have been developed to utilize the telephone coil of a hearing aid. Thus, in hearing aids with telephone coils, it may be desirable to automatically switch the hearing aid from a microphone input to a telephone coil when answering on a telephone.

The use of a telephone coil addresses other problems associated with using a received acoustic signal from a microphone. Because of the proximity of the telephone handset to the hearing aid, an acoustic feedback loop can be formed that may result in oscillation or a squealing sound as that often heard with public address systems. Use of the telephone coil eliminates these acoustic feedback problems and room noise. However, the telephone coil takes up additional space that may preclude its use in smaller model custom hearing aids. Other embodiments for automatic switching in conjunction with using a telephone or other communication device can address the space problems associated with a voice pickup coil such as a telephone coil.

Further problems associated with acoustic coupling of signals from the telephone handset to the hearing aid include creating a leakage path that allows low frequency signals to leak away in the air due to the telephone handset not held tightly to the hearing aid microphone.

The magnetic switches, discussed above, have been used to regulate the alternative operation of the telephone coil and the microphone. However, these switches may fail or may not be operable with some devices that can utilize a telephone coil. Accordingly, a need exists for a hearing aid that provides an alternative method for switching between the telephone coil, the microphone and different programs.

However, as hearing aids have developed, increasingly small circuits, computer processors and memory systems have permitted the use of a plurality of settings stored in memory or in alternative circuit configurations for each input. In prior hearing aids, multiple settings have been provided in memory to alter the settings from microphone inputs of a hearing aid to accommodate a variety of situations. Particularly, these settings have been provided to optimize the settings for normal conversation, conversations in noisy environments, listening to music, directional hearing, among others. The settings for these hearing aids are typically changed through the use of a mechanical or magnetic switch so that the user may manually cycle through the programs. In one type of hearing aid, two settings have been provided to alternatively configure settings for a single input between a mode for normal hearing and a mode for telephone conversations. This device can utilize a magnetic switch which is activated upon placement of the handset to the ear to alternate between the normal and the telephone modes.

However, prior devices which switch between inputs or programs to alternate between telephone and normal hearing use upon detection of a magnetic field from a telephone earpiece have not typically been provided with a plurality non-telephonic settings. Accordingly, the user of a hearing aid that is configured for alternative use between telephone and normal conversation has not been provided with the flexibility offered by a plurality of settings for non-telephonic applications. Therefore, a need exists for a method and apparatus which provides multiple inputs as well as offering a plurality of settings for at least one of the inputs.

### SUMMARY OF THE INVENTION

The apparatus and method of the present invention satisfies the above needs and provides additional advantages that will be recognized by those skilled in the art upon review of the present disclosure.

In one aspect, the present invention can provide a hearing aid having a microphone, a telephone coil, a signal processor, a magnetic switch and a manual switch. The microphone can provide a microphone electrical signal representative of an acoustic signal. The telephone coil can provide a telephone coil electrical signal representative of an acoustic signal. The signal processor can configure one of the microphone electrical signal and the telephone coil electrical signal. The magnetic switch can communicate with the microphone and with the telephone coil to switch between receiving the electrical signal from the microphone and the electrical signal from the telephone coil. The manual switch can communicate with at least the microphone. The hearing aid may further include a memory to store at least a first program and a second program to control the configuration of the microphone electrical signal by the signal processor. The memory may also store at least a third program to control the configuration of the telephone coil electrical signal by the signal processor.

In another aspect, the present invention can provide a hearing aid having a microphone, a telephone coil, a signal processor, a memory, and a magnetic switch. The hearing aid may also include a manual switch to communicate with the microphone and with the telephone coil to manually switch between receiving the electrical signal from the microphone and the electrical signal from the telephone coil. The microphone can provide a microphone electrical signal representative of an acoustic signal. The telephone coil can provide a telephone coil electrical signal representative of an acoustic signal. The signal processor can communicate with at least one of the microphone and the telephone coil to configure one of the microphone electrical signal and the telephone electrical signal. The memory can store a plurality of selectable preset programs communicating with the signal processor which are implemented by the signal processor, including: at least a first program and at least a second program to configure the microphone electrical signal and at least a third program to configure telephone coil electrical signal. The magnetic switch can communicate with the microphone and with the telephone coil to switch between receiving the electrical signal from the microphone and the electrical signal from the telephone coil. The magnetic switch may also communicate with the memory to switch between the first program and the second program to configure the microphone electrical signal and the third program to configure the telephone coil electrical signal. The manual switch can communicate with the memory to manually switch between the first program and the second program to configure the microphone electrical signal and the third program to configure the telephone coil electrical signal.

In yet another aspect, the present invention can provide a hearing aid having a first microphone, a second microphone, a telephone coil, a signal processor, a magnetic switch and a memory. The hearing aid can also include a manual switch communicating with at least one of the first microphone and the second microphone and with the telephone coil to manually switch between receiving at least one of the first microphone electrical signal and the second microphone electrical signal, and the from the telephone coil electrical signal. The first microphone can provide a microphone electrical signal representative of an acoustic signal. The second microphone can provide a microphone electrical signal representative of an acoustic signal. The telephone coil can provide a telephone coil electrical signal representative of an acoustic signal. The signal processor can communicate with at least one of the first microphone, second microphone and the telephone coil to configure at least one of one of the first microphone electrical signal, the second microphone electrical signal, and the telephone coil electrical signal. The memory can store a plurality of selectable preset programs communicating with the signal processor which are implemented by the signal processor, including: at least a first program and at least a second program to configure at least one of the first microphone electrical signal and the second microphone electrical signal, and at least a third program to configure telephone coil electrical signal. The magnetic switch can communicate with the first microphone and the second microphone and with the telephone coil to switch between receiving the electrical signals from at least one of the first microphone and the second microphone, and from the electrical signal from the telephone coil. The magnetic switch may also communicate with the memory to switch between the first program and the second program to configure at least one of the first microphone electrical signal and the second microphone electrical signal, and the third program to configure the telephone coil electrical signal. The manual switch can also communicate with the memory to manually switch between the first program and the second program to configure at least one of the first microphone electrical signal and the second microphone electrical signal, and the third program to configure the telephone coil electrical signal.

### BRIEF DESCRIPTION OF THE DRAWINGS

FIG. 1 illustrates a hearing aid in accordance with the present invention placed within the ear of a user and having the earpiece of a telephone placed adjacent to the ear.

FIG. 2 illustrates a schematic view of an embodiment of components of a hearing aid in accordance with the present invention.

All figures are drawn for ease of explanation of the basic teachings of the present invention only; the extensions of the figures with respect to number, position relationship and dimensions of the parts to form the preferred embodiment will be explained or will be within the skill of the arts after the following description has been read and understood. Further, the exact dimensional proportions to conform to specific force, weight, strength, and similar requirements will likewise be within the skill of the art after the following description has been read and understood.

Where used in various figures of the drawings, the same numerals designate the same or similar parts. Furthermore, when the terms “top,” “bottom,” right,” “left,” “forward,” “rear,” “first,” “second,” “inside,” “outside,” and similar terms are used, the terms should be understood to reference only the structure shown in the drawings as it would appear to a person viewing the drawings and reading the specification and should be utilized only to facilitate the description of the illustrated embodiment.

### DETAILED DESCRIPTION OF THE INVENTION

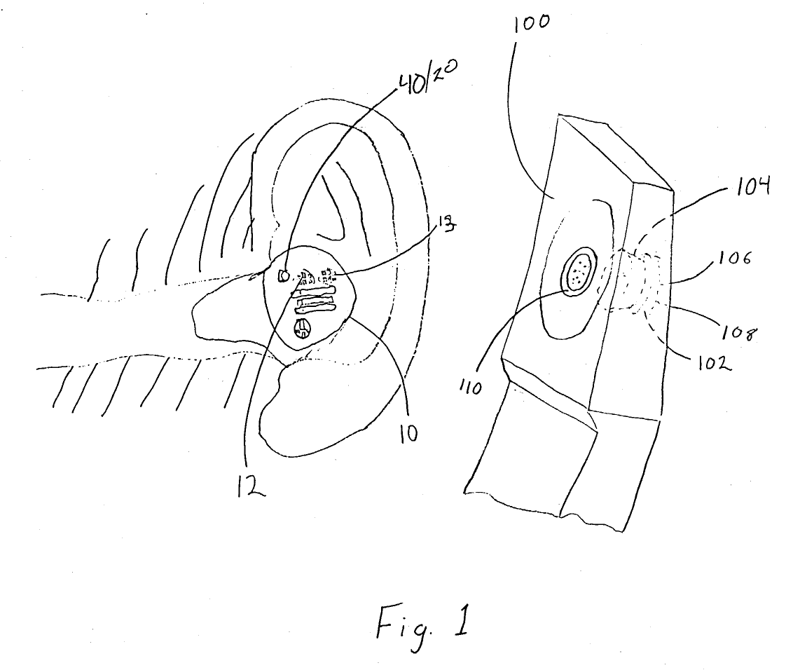

FIG. 1 illustrates a hearing aid 10 in accordance with the present invention. Hearing aid 10 may be a digital hearing aid or a programmable analog hearing aid. Hearing aid 10 is shown as an in-the-ear type hearing aid for exemplary purposes. A behind-the-ear aid, completely-in-the-ear hearing aid or other type of hearing aid could also embody the present invention. A hearing aid 10 in accordance with the present invention can include a microphone 12, a telephone coil 14, an input switch 16, magnetic switch 18, a manual switch 20, a setting selector 24, and a signal processor 28. In addition, hearing aid 10 may include a second microphone 13 which may be used, for example, in conjunction with a directional hearing setting. Additional switches or other controls as well as additional inputs may also be incorporated into the present invention. Although a telephone coil 14 is particularly disclosed, other non-microphone components for receiving signals are contemplated to be equivalent to the disclosed telephone coil.

A telephone earpiece 100 is also illustrated in FIG. 1. Telephone earpieces typically include a permanent magnet 102 associated with the speaker 104 in earpiece 100. Otherwise another supplement magnet 110 may be attached to earpiece 100 or generally in the proximity of earpiece 100 to activate magnetic switch 18. Speaker 104 is generally pressed adjacent the ear 200 of a user during a telephone conversation. Magnet 102 may be associated with an electromagnetic transducer 106 and a voice coil 108 fixed to a speaker cone. Typically, voice coil 108 receives the time-varying component of the electrical voice signal and moves relative to stationary magnet 102. Thereby, voice coil 108 moves the speaker cone to create an audible pressure wave or sound.

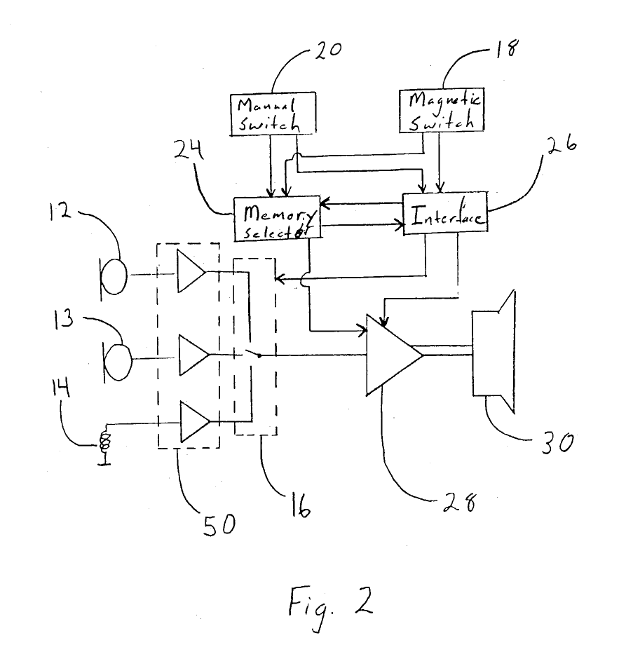

FIG. 2 illustrates a schematic view of an embodiment for a hearing aid 10 in accordance with the present invention. As illustrated for exemplary purposes, hearing aid 10 includes three inputs: a first microphone 12, a second microphone 13 and a telephone coil 14.

Generally, first microphone 12 is configured to receive an acoustic signals and to provide an electrical signal representative of the received acoustic signal. Similarly, second microphone 13 is also generally configured to receive an acoustic signals and to provide an electrical signal representative of the received acoustic signal. The second microphone 13 may function in conjunction with the first microphone 12 to provide a number of functions as will be recognized by those skilled in the art. The acoustic signal can be generated from a variety of sources. These acoustic signals can be broken down in to a number of components, including, among other components, amplitude and frequency and further, into sub-components such as for example low frequencies, mid-range frequencies and a high frequencies. For example in operation, microphone 12 may receive acoustic signals, convert them into first microphone electrical signals, and transmit the first microphone electrical signals to signal processor 28. Signal processor 28 may generally provide signal processing functions which can include noise reduction, amplification, tone control, among other functions. Signal processor 28 generally outputs an electrical signal to an output 30 which is typically a receiver that transmits sound directly into the wearer's ear.

Telephone coil 14 is generally configured to receive a magnetic signal and to provide an electrical signal representative of the magnetic signal. The magnetic signal can be generated from a variety of sources but are typically generated by a voice coil 108 of a telephone. The magnetic signals can be broken down in to a number of components, including amplitude and frequency and further, into sub-components such as for example low frequencies, mid-range frequencies and a high frequencies. Telephone coil 14 receives magnetic signals, converts them into telephone coil electrical signals and transmits the telephone coil electrical signals to signal processor 28. Signal processor 28 provides various signal processing functions which can include noise reduction, amplification, and tone control. Signal processor 28 outputs an electrical signal to an output 30 which is typically a receiver that transmits sound directly into the wearer's ear.

Telephone coil 14 is typically an inductive element or an electromagnetic transducer that senses the magnetic field gradient produced by movement of telephone voice coil 108 and in turn produces a corresponding electrical signal which is transmitted to the signal processor 28. Telephone coil 14 can more efficiently translates the magnetic signals from voice coil 108 in earpiece 100 than microphone 12 can translate the sound waves from the speaker in earpiece 100. Telephone coils 14 can generally more effectively reduce the background noise by directly picking up the voice signal from the magnetic field gradient produced by the voice coil 108.

Input switch 16 is typically provided to alternatively select which input or inputs are being sent to signal processor 28. Generally, input switch 16 closes a switch and completes a conductive path between two conductive terminals although the switch may be configured in any number of variations or combinations of components without departing from the scope of the present invention. As illustrated, the position of input switch 16 may be determined by either manual switch 20 or magnetic switch 18. As generally illustrated for exemplary purposes, the position of input switch 16 may be regulated by an interface 26 that receives its input from either manual switch 20 and/or magnetic switch 18. In yet another aspect of the present invention, the position of input switch 16 may be directly determined by the presence or absence of a magnetic field 102. For exemplary purposes, input switch 16 has been illustrated to switch between first microphone 12, second microphone 13 and telephone coil 14. In one aspect, switch 16 may be configured to simultaneously transmit signals from both first microphone 12 and second microphone 13.

Memory selector 24 typically includes a plurality of programs stored in a memory or settings configured into alternative responses to control the manipulation of a signal by signal processor 28. Signal processor 28 is typically includes a microprocessor configured to implement signal modification programs stored in memory selector 24. Signal processor 28 can digitally modify the frequency response or other responses of hearing aid 10, according to the selected program that is stored in memory selector 24 to supplement the frequency and other characteristics of the individual using the hearing aid. The modifications can include amplification, digital filtering, noise reduction, tone control, and other digital signal processing for a hearing aid as known by those skilled in the art.

In another aspect, signal processor may be configured to process signals analog and can be switchable between a variety of settings. Signal processor 28 may be followed by an amplifier or may include an amplifier and other conventional signal processing devices to amplify the signal to the receiver for generating an audible sound representative of the acoustic signal received from either microphone 12 or telephone coil 14. Further, one or more preamplifiers 50 may be provided to amplify the signals from the inputs prior to their communication to signal processor 28.

Memory selector 24 stores at least one program or setting for configuring the input from telephone coil 14 and may store at least one program or setting for configuring the input from microphone 12. These programs or settings are implemented by signal processor 28 to set the operating levels and device characteristics of hearing aid 10 for modifying an electrical signal derived from the acoustic signal received by microphone 12 and for modifying the electrical signal derived from the magnetic signal received by telephone coil 14. Memory selector 24 may include a plurality of memory storage components which store the plurality of programs to configure signal processor 28. Memory selector 24 may be programmable to permit the reconfiguration of the program to adapt to the changing hearing characteristics of a user or to simply configure the settings for a particular user.

In one aspect, first program, second program, and any additional programs may be coupled to signal processor 28 upon being enabled by magnetic switch 18 or manual switch 20 either directly or through an interface. First program, second program, and any additional programs in memory selector 24 can be coupled to signal processor 28 by a common bus, where magnetic switch 18 or manual switch 20 enables the placing of data, representing parameters from first program, second program, or any additional programs in memory selector 24, onto the common bus.

In another aspect, magnetic switch 18 can be coupled to signal processor 28 and first program and second program in memory selector 24, where the parameters are provided to signal processor 28 through magnetic switch 18 from the first program and the second program depending on the presence or absence of a magnetic field and with manual switch 20 in a first position. With manual switch 20 in a second position, magnetic switch 18 can be coupled to signal processor 28 and first program and third program in memory selector 24, where the parameters are provided to signal processor 28 through magnetic switch 18 from the first program and the third program depending on the presence or absence of a magnetic field.

Generally, a one program or setting is provided for configuring the signal from microphone 12 and another program or setting is provided for configuring the signal from telephone coil 14. Alternatively, the telephone coil may not include a particularized program or setting to configure the telephone coil signal. A third program or setting and additional programs or settings may also be stored in memory selector 24 to provide alternative configurations for the signals from telephone coil 14 or microphone 12. In one aspect, the additional programs or settings are provided for configuration of the signal from the microphone 12 or microphone 13 to optimize situation specific parameters such as, for example, conversations in a noisy environment, reducing electrical noise in a quiet environment, speaking on a telephone not compatible with telephone coil 14, and other situation specific parameters that will be recognized by those skilled in the art upon review of the present disclosure.

Magnetic switch 18 can be a reed switch, micro machined sensor, reed relays, or other devices capable of switching an electrical current in response to a magnetic field. Magnetic switch 18 is provided to switch between the sound inputs 12 and/or 13 and telephone coil 14. Typically, magnetic switch 18 is provided to switch the hearing aid input from the microphone 12, the default state, to the telephone coil 14, which is typically the magnetic field sensing state. Further, magnetic switch 18 may be configured to switch from a first program or setting for configuring a signal from microphone 12 to a second program or setting for configuring a signal from a telephone coil 14 as the inputs are alternated. As is illustrated in FIG. 2 for exemplary purposes, magnetic switch 18 may direct a signal to an interface 26 that changing the source of the input from microphone 12 and/or microphone 13 to the telephone coil 14, then start checking the memory selector 24 and if a special memory is dedicated to telephone coil response it will switch to this memory, if not such memory exist the memory will not change. As soon as the magnetic switch is deactivated the input switch 16 will restore the prior input and interface 26 will restore the prior memory. Generally, the magnetic switch 18 is configured to switch from microphone input and a microphone program or setting to telephone coil 14 and, if available, the telephone coil program or setting in the presence of a sufficient magnetic field such as when magnet 102 or supplemental magnet 110 is positioned adjacent to a user's ear and return back to microphone input and the privies microphone program when the magnetic field is removed. Accordingly, magnetic switch 18 can eliminate the need for the wearer to manually switch the input of the hearing aid when answering a telephone call and after the call is over.

Manual switch 20 is typically switched by a button 40 that is positioned on the outside of the housing of hearing aid 10 or is otherwise configured to be accessed by a wearer. Manual switch 20 generally permits the user to switch between the various programs or settings in memory selector 24 and may be used to switch between the inputs being utilized. As is illustrated for exemplary purposes, manual switch 20 may be configured to directly communicate with the memory selector 24 to select the program implemented by signal processor 28 while also communicate with interface if the change of the source of the input is necessary. In one embodiment, manual switch 20 permits the user to switch between microphone 12 using a microphone program or setting in memory selector 24 and telephone coil 14 using a telephone coil program or setting in memory selector 24. In another embodiment, manual switch 20 may solely permit the switching between a few programs or settings in memory selector 24 for configuring the output generated by microphone 12. In yet another embodiment, manual switch 20 may solely permit the switching between a few programs or settings in memory selector 24 for configuring the output generated by microphones 12 and/or microphone 13 using programs and settings in memory selector 24. In still another embodiment, manual switch 20 permits the user to switch between microphone 13 and each of a plurality of programs in memory selector 24 for configuring the signal from telephone coil 14 and a plurality of programs distinct from the telephone coil's programs or settings in memory selector 24.

In one aspect of operation, microphone 12, microphone 13 and telephone coil 14 alternatively provide the input to signal processor 28. The configuration of the signals from the inputs are controlled by at least a few programs or settings in memory selector 24. Microphone 12 or 13 receives an acoustic signal. An electrical signal representative of the acoustic signal is passed from microphone to signal processor 28, where signal processor 28 modifies the electrical signal and provides an output signal representative of the acoustic signal to a speaker. The modifications made by signal processor 28 can include amplification, acoustic feedback reduction, noise reduction, and tone control, among other signal processing functions as are known to those skilled in the art.

A particular program or setting in memory selector 24 may be adapted to provide parameters for operating hearing aid 10 in conjunction with a telephone or other audio providing communication device used in proximity to hearing aid 10. These program used by signal processor 28 to modify a response may boost a low frequency gain and reduce a high frequency gain. In one configuration, the high frequency gain is reduced to substantially reduce the high frequency component of the electrical signal representing the received acoustic signal. Can increase or decrease overall gain or output in accordance with customer needs. Another program in memory selector 24 may be adapted to provide standard parameters for operating hearing aid 10. The program typically modifies the electrical signal representing the received acoustic signal to provide an enhanced signal to a hearing aid speaker. These parameters allow signal processor 28 to modify a frequency response conforming to a prescription target for standard operation of hearing aid 10 in its local environment. These prescription targets are known to those skilled in the art. Many different parameters and special options like Speech Management System, Microphone Noise Reduction, Feedback Manager System, etc. can be adjusted or modify and store in memory selector 24.

In an exemplary configuration for control of apparatus 10, manual switch 20 is provided to cycle through at least a first program, a second program and a third program to control the signal processor's 28 configuration of the output signal from first microphone 12. Magnetic switch 18 switches from the microphone 12 and the microphone's current program to telephone coil 14 upon the detection of a sufficient magnetic field. Upon removal of the magnetic field, the input is returned to the prior microphone and the microphone's prior setting.

In another exemplary embodiment control of hearing aid 10, manual switch 20 is provided to switch between at least a first program and a second program to control the signal processor's 28 configuration of the output from first microphone 12 and a third program to control the signal processor's 28 configuration of the output from the telephone coil 14. Magnetic switch 18 switches apparatus 10 from microphone 12 and the microphone's current program to telephone coil 14 and a third program to configure the output from telephone coil 14. Upon removal of the magnetic filed, the input is returned to the settings in effect prior to detecting the magnetic field.

In yet another exemplary configuration for control of apparatus 10, manual switch 20 is provided to cycle through a first program to control the signal processor's 28 configuration of the output signal from first microphone 12 and through at least a second program and a third program to control the signal processor's 28 configuration of the output signal from first microphone 12. If manual switch 20 is not set to receive its input from telephone coil 14, magnetic switch 18 switches from the first microphone 12 to the telephone coil input upon the detection of a sufficient magnetic field, but the program setting will not change. Upon removal of the magnetic field, the input is returned to the first microphone 12.

In yet another exemplary configuration for control of hearing aid 10, manual switch 20 is provided to cycle through at least a first program and a second program to control the signal processor's configuration of the output signal from first microphone 12; and through a third program to control the signal processor's simultaneous configuration of the output signal from first microphone 12 and second microphone 13 in association with, for example, a directional hearing setting. Magnetic switch 18 switches from the first microphone input or first microphone 12 and second microphone 13 inputs to the telephone coil input upon the detection of a sufficient magnetic field and the program setting will not change. Upon removal of the magnetic field, the input is returned to microphone's prior setting.

Since the invention disclosed above may be embodied in other specific forms without departing from the spirit or general characteristics thereof, some of which forms have been indicated, the embodiments described in the present disclosure are to be considered in all respects illustrative and not restrictive. The scope of the invention is to be indicated by the appended claims, rather than by the above description, and all changes which come within the meaning and range of equivalency of the claims are intended to be embraced by the claims.

What is claimed is:

1. A hearing aid, comprising:
a microphone to provide a microphone electrical signal representative of an acoustic signal;
a telephone coil to provide a telephone coil electrical signal representative of an acoustic signal;
a signal processor to configure one of the microphone electrical signal and the telephone coil electrical signal;
a magnetic switch communicating with the microphone and with the telephone coil to switch between receiving the electrical signal from the microphone and the electrical signal from the telephone coil; and
a manual switch communicating with at least the microphone.

2. A hearing aid, as in claim 1, further comprising memory storing at least a first program and a second program to control the configuration of the microphone electrical signal by the signal processor.

3. A hearing aid, as in claim 2, further comprising memory storing at least a third program to control the configuration of the telephone coil electrical signal by the signal processor.

4. A hearing aid, as in claim 1, further comprising at least a first program and at least a second program to configure the microphone electrical signal and at least a third program to configure telephone coil electrical signal.

5. A hearing aid, comprising:
a microphone to provide a microphone electrical signal representative of an acoustic signal;
a telephone coil to provide a telephone coil electrical signal representative of an acoustic signal;
a signal processor communicating with at least one of the microphone and the telephone coil to configure one of the microphone electrical signal and the telephone electrical signal;
a memory to store a plurality of selectable preset programs communicating with the signal processor which are implemented by the signal processor, including: at least a first program and at least a second program to configure the microphone electrical signal and at least a third program to configure telephone coil electrical signal and
a magnetic switch communicating with the microphone and with the telephone coil to switch between receiving the electrical signal from the microphone and the electrical signal from the telephone coil.

6. A hearing aid, as in claim 5, further comprising a magnetic switch communicating with the memory to switch between the first program and the second program to configure the microphone electrical signal and the third program to configure the telephone coil electrical signal.

7. A hearing aid, as in claim 5, further comprising a manual switch communicating with the microphone and with the telephone coil to manually switch between receiving the electrical signal from the microphone and the electrical signal from the telephone coil.

8. A hearing aid, as in claim 7, further comprising a manual switch communicating with the memory to manually switch between the first program and the second program to configure the microphone electrical signal and the third program to configure the telephone coil electrical signal.

9. A hearing aid, comprising:
a first microphone to provide a microphone electrical signal representative of an acoustic signal;
a second microphone to provide a microphone electrical signal representative of an acoustic signal;
a telephone coil to provide a telephone coil electrical signal representative of an acoustic signal;
a signal processor communicating with at least one of the first microphone, second microphone and the telephone coil to configure at least one of one of the first microphone electrical signal, the second microphone electrical signal, and the telephone coil electrical signal;
a memory to store a plurality of selectable preset programs communicating with the signal processor which are implemented by the signal processor, including: at least a first program and at least a second program to configure at least one of the first microphone electrical signal and the second microphone electrical signal, and at least a third program to configure telephone coil electrical signal; and
a magnetic switch communicating with the first microphone and the second microphone and with the telephone coil to switch between receiving the electrical signals from at least one of the first microphone and the second microphone, and from the electrical signal from the telephone coil.

10. A hearing aid, as in claim 9, further comprising a magnetic switch communicating with the memory to switch between the first program and the second program to configure at least one of the first microphone electrical signal and the second microphone electrical signal, and the third program to configure the telephone coil electrical signal.

11. A hearing aid, as in claim 9, further comprising a manual switch communicating with at least one of the first microphone and the second microphone and with the telephone coil to manually switch between receiving at least one of the first microphone electrical signal and the second microphone electrical signal, and the from the telephone coil electrical signal.

12. A hearing aid, as in claim 11, further comprising a manual switch communicating with the memory to manually switch between the first program and the second program to configure at least one of the first microphone electrical signal and the second microphone electrical signal, and the third program to configure the telephone coil electrical signal.
